(19) United States
(12) Patent Application Publication
(10) Pub. No.: US 2010/0018459 A1
(43) Pub. Date: Jan. 28, 2010

(54) IMMERSION BATH ROLL AND A METHOD FOR THE MANUFACTURE OF AN IMMERSION BATH ROLL

(76) Inventors: Karsten Gnoyke, Oyten (DE); Christian Doding, Elbe (DE); Franz Jansen, Baesweiler (DE)

Correspondence Address: ROBERT S. GREEN, SULZER METCO (US), INC., 1101 PROSPECT AVENUE, WESTBURY, NY, 11590, US

(21) Appl. No.: 12/501,752

(22) Filed: Jul. 13, 2009

(30) Foreign Application Priority Data
Jul. 14, 2008 (EP) 08160351.6

(51) Int. Cl. B05C 3/132; B05D 1/08; C23C 4/06; C23C 4/10

(52) U.S. Cl. 118/423; 427/446; 427/455

(57) ABSTRACT

In accordance with the invention an immersion bath roll is suggested for an immersion bath with liquid metal with a roll body (2), extending along a longitudinal axis (A), as well as essentially cylindrical bearing journals (3) for the cooperation with bearing sleeves for the mounting of the immersion bath roll (1, 1a, 1b), wherein each bearing journal (3) possesses at least one groove (4), which extends in the circumferential over the total circumference of the bearing journal (3), and which is filled with a protective layer (41) produced by thermal spraying.

The present invention relates to an immersion bath roll for an immersion bath with liquid metal as well as to a method for the manufacture of an immersion bath roll in accordance with the preambles of the independent claims of the respective categories.

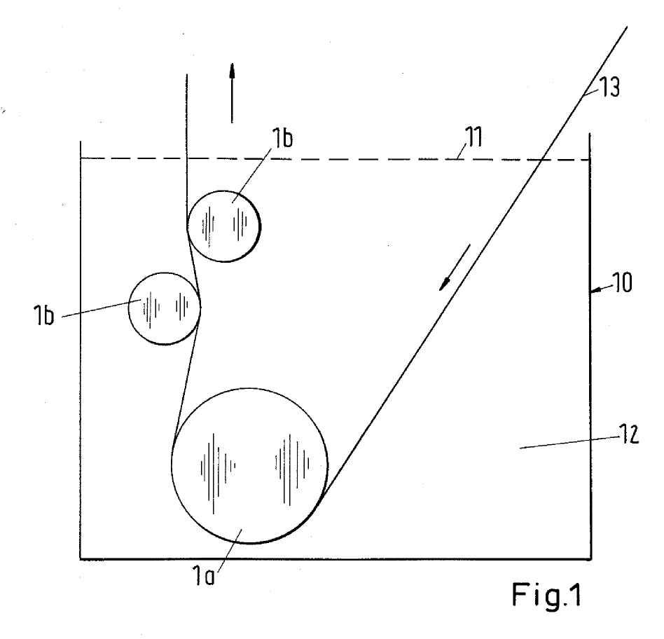

For the metallic coating of strip materials, for example sheet metal or other production parts in the steel industry, it is known, that these are drawn through an immersion bath of liquid metal, to achieve the required coating. Examples of this are the aluminizing or the galvanizing of sheet metal, also known as hot aluminizing or hot galvanizing. In this, the sheet metal to be coated (see FIG. 1), existing in the shape of a strip, is drawn through a tank, in which the desired material for example aluminium or zinc, is contained in a molten state. Typically several rolls are provided for the guiding of the strip, which are entirely immersed in the molten metal. One typically distinguishes between the pot rolls, with which the strip is deflected and the support rolls, which stabilize the run of the strip.

In the following, both the support rolls and the pot rolls will be summarized using the generic term immersion bath rolls.

The journaling of the immersion bath rolls during hot aluminizing or galvanizing is a serious problem, due to the aggressive nature of the liquid metals. During hot aluminizing in particular, the aluminium or the aluminium silicon melt attack the mechanical bearings of the immersion bath rolls.

Frequently the bearing journals or spigots, which can be massive journals or a core with a sleeve arranged on it, are manufactured from stellites. The counter running partner of the bearing journals are also typically manufactured from stellites or ceramics.

Due to the tribo-corrosive attack of the liquid molten metal, and also the combination of corrosive attacks and friction between the bearing elements undergoing relative rotation, the bearing journals are subjected to an extremely heavy wear. During continuous strip aluminizing, the bearing journals and/or the sleeves only have a working life of at most 3-5 days. Thereafter the metallurgical break up and the degradation due to friction of the bearing journals is so great that the immersion bath rolls have to be exchanged.

Starting from this prior art, it is the object of this invention to provide an immersion bath roll with which significantly increased working lives can be achieved in metallic immersion baths, in particular in aluminium and zinc baths. Furthermore, another object of the invention is, to provide a procedure for the manufacture of such immersion bath rolls.

The subject matter of the invention satisfying these is characterized by the independent claims of the respective category.

In accordance with the invention an immersion bath roll is suggested for an immersion bath with liquid metal with a roll body extending along a longitudinal axis, as well as an essentially cylindrical bearing journals for the cooperation with journal sleeves for the mounting of the immersion bath roll, wherein each bearing journal has at least one groove which extends in the circumferential direction over the total circumference of the bearing journal and which is filled up with a protective layer produced by thermal spraying.

It has been shown that a significantly better resistance against both the tribologically caused wear as well as against the corrosive attack of the liquid metals, in particular of liquid aluminium or zinc, is achieved by the this protective layer provided in the groove.

The protective layer preferably contains molybdenum, molybdenum carbide (Mo₂C, MoC) or a mixture of molybdenum and molybdenum carbide (Mo₂C, MoC). Using these materials a significant increase in the lifetime of the immersion bath rolls can be achieved. In particular it is preferred when the molybdenum content or the molybdenum carbide content or the content of the mixture of molybdenum and molybdenum carbide of the protective layer is at least 40 percent by weight.

In accordance with a preferred embodiment a plurality of grooves is provided at each bearing journal, with neighbouring grooves respectively being separated by a web. The webs give the bearing journals the required mechanical stability.

In practice the following measures have shown to be of advantage:

For each bearing journal the webs constitute at least 30% of the surface area of the bearing journal

each web has a width of 3 mm to 15 mm,

each groove has a width of 3 mm to 20 mm

each groove has a depth of at least 50 micrometers and particular by preferably a depth of 100 to 200 micrometers.

A further advantageous measure consists in that the protective layer is additionally provided on the webs, with the protective layer on the surface of the webs having a thickness of at least 20 micrometers and preferentially from 50 to 100 micrometers. Through this measure the surface of the webs can be effectively protected.

Moreover, through the invention, a method for the manufacture of an immersion bath roll for an immersion bath with liquid metal is proposed with a roll body which extends along a longitudinal axis, as well as essentially cylindrical bearing journals, for cooperation with bearing sleeves, wherein at least one groove is provided in each bearing journal, and extends in the circumferential direction over the total circumference of the bearing journal, and with the groove being filled with a protective layer via the means of thermally induced spraying.

Preferentially the groove is filled with a medium containing molybdenum or molybdenum carbide.

In particular it is advantageous to fill the groove by means of plasma spraying, or flame spraying or arc spraying.

Further advantageous measures and preferred embodiments of the invention result from the dependent claims.

The present invention will be described in more detail in the following, with reference given to embodiments and the drawings. In the schematic drawings there are shown, partly in section:

FIG. 1 a schematic representation of an immersion bath for the coating with a liquid metal,

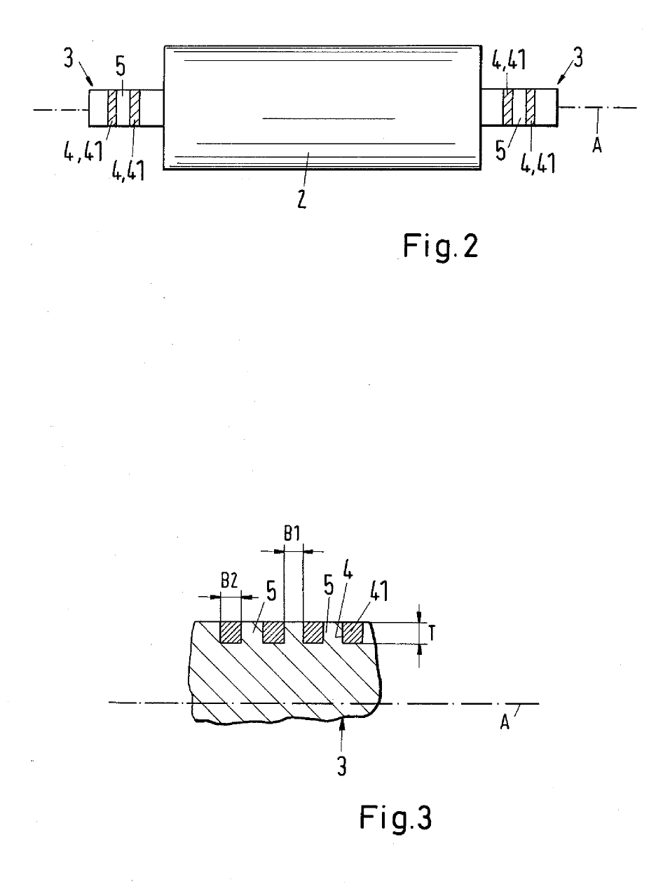

FIG. 2 a schematic representation of an embodiment of an immersion bath roll in accordance with the invention,

FIG. 3 a section through a bearing journal of an embodiment of an immersion bath roll in accordance with the invention, and

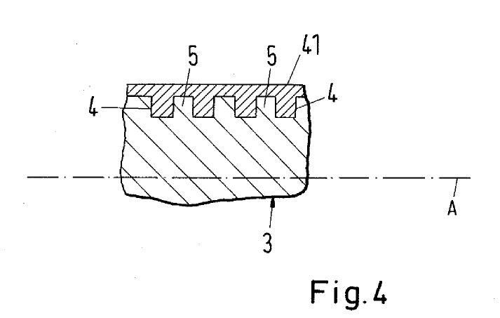

FIG. 4 a variant for the embodiment of FIG. 3.

FIG. 1 shows a schematic representation of an immersion bath for coating metal strips, in particular steel strips, with a metal. In the following reference will be made to the embodiment which is especially important in practice in which the coating is to be made of aluminium. It will be understood, that the invention is not limited to such applications, but can also be used with other metals or alloys, as for example galvanizing.

The immersion bath includes a tank 10 which is filled with liquid aluminium 12 to a level line 11. In the tank a pot roll 1a, as well as two support rolls 1b are provided. As the invention can be used for both the pot roll 1a and the support rolls 1b, the generic term “immersion bath roll 1” will be used in the following which both the pot roll 1a and/or the support roll 1b or the support rolls 1b are meant.

The metal strip 13 to be coated, in particular a steel strip, is moved through the liquid aluminium 12, moves around the pot roll 1a, where it is deflected, then passes through the two support rolls 1b before leaving the tank 10. The movement of the metal strip 13 is illustrated in FIG. 1 by the two arrows without reference numerals.

FIG. 2 shows in a schematic representation an embodiment of an immersion bath roll 1 in accordance with the invention, which can be configured as either a pot roll 1a or a support roll 1b. The immersion bath roll 1 has a generally cylindrical shape with a roll body 2 extending along the longitudinal axis A. An essentially cylindrical bearing journal 3 is provided at each of the two base areas of the cylindrical roll body 2 and extends concentri- cally to the roll body 2 in the direction of the longitudinal axis A. The bearing journals cooperate with bearing sleeves, not illustrated here, so that the immersion bath roll 1 can be rotationally mounted in the tank 10.

The bearing journal 3 can either be constructed as a massive journal that is manufactured in one piece with the ring body, or can be rotationally fixedly connected to the roll body 2, for example by welding, or the bearing journal 3 can include a cylindrical core, on which a sleeve is rotationally fixedly mounted.

The basic material of which the roll body 2 and/or the bearing journals consist, is any material known in the prior art for immersion bath rolls, for example 100Cr6 steel.

In accordance with the invention at least one groove 4 is provided on each bearing journal 4, which extends over the full circumference of the envelope surface of the bearing journal, thereby forming a ring shaped recess in the bearing journal.

FIG. 3 shows a sectional representation of an embodiment of the bearing journal 3. In this embodiment a total of four grooves 4 are provided, which are each separated from one another by webs 5.

The grooves 4 are each filled with a protective layer 41, which preferentially contains molybdenum, molybdenum carbide (Mo₂C, MoC) or a mixture of molybdenum and molybdenum carbide. In particular it is preferred, when the molybdenum content or the molybdenum carbide (Mo₂C, MoC) content of the protective layer 41, or the content of the mixture of molybdenum and molybdenum carbide of the protective layer 41, is at least 40 percent by weight.

The manufacturing of the immersion bath roll in accordance with the invention is performed in particular in such a way. First of all the roll body 2 is manufactured together with the bearing journals 3 in the known way. Following this, in a material removing machining step, the grooves 4 are manufactured, for example, by milling. These are then filled up with a protective layer in a thermal spraying process, either by plasma spraying, or by flame spraying, or by arc spraying.

In the thermal spraying process the webs can also be covered with a layer of a thickness of at least 20 μm, and of preferably 50 to 100 μm, so that the protective layer not only fills up the grooves 4 but also protects the surface of the webs 5. It is the primary object of the webs 5, to give the bearing journal 3 the required stability. Such a variant is indicated in FIG. 4

Following the thermal spraying process the coating of the bearing journal 3 is levelled out by grinding and/or polishing, so that the bearing journal has a smooth surface as a whole. Optionally, following the grinding, a known sealing process can be carried out. For this a chrome containing glaze is applied to the journal and then fired.

With the immersion bath roll in accordance with the invention, in an aluminium bath that typically has a temperature of 680° C., working lives of up to 15 days and more can be achieved, with a significantly smoother running of the immersion bath rolls being observed at the same time, in contrast to immersion bath rolls known from the prior art.

In practice it has proved to be especially advantageous, if the following geometric criteria are satisfied (see FIG. 3).

For every bearing journal the webs 5 constitute at least 30% of the surface area of the bearing journal 3.

Every web has a width B1 of 3 mm to 15 mm.

Every groove has a width B2 of 3 mm to 20 mm.

Every groove has a depth T of at least fifty micrometers and a particularly preferred depth ranging from 100 μm to 200 μm.

It will be understood, that the grooves 4 and/or the webs 5 can be arranged equidistantly, but do not have to be. It is also not necessary but possible, that all grooves 4 and/or all webs 5 have the same width B1, B2 or the same depth T.

Depending on the application it can be advantageous, to provide the roll body 2 with circumferential grooves, which are filled up with a protective layer in a thermal spraying process, in an analogous way to the bearing journals 3.

1. An immersion bath roll for an immersion bath with liquid metal with a roll body (2) extending along a longitudinal axis (A), as well as essentially cylindrical bearing journals (3) for the cooperation with bearing sleeves for the mounting of the immersion bath roll (1, 1a, 1b), characterized in that each bearing journal (3) has at least one groove (4), which extends in the circumferential direction over the total circumference of the bearing journal (3) and which is filled up with a protective layer (41) produced by thermal spraying.

2. An immersion bath roll in accordance with claim 1, wherein the protective layer (41) contains molybdenum, molybdenum carbide or a mixture of molybdenum and molybdenum carbide.

3. An immersion bath roll in accordance with claim 2, wherein the molybdenum content or the molybdenum carbide content or the content of the mixture of molybdenum and molybdenum carbide of the protective layer (41) is at least 40 percent per weight.

4. An immersion bath roll in accordance with claim 1, wherein a plurality of grooves (4) is provided on each bearing journal (3), wherein neighbouring grooves (4) are separated by a web (5).

5. An immersion bath roll in accordance with claim 4, wherein for each bearing journal (3) the webs (5) form at least 30% of the surface area of the bearing journal (3).

6. An immersion bath roll in accordance with claim 4, wherein each web (5) has a width (B1) of 3 mm to 15 mm.

7. An immersion bath roll in accordance with claim 1, wherein each groove (4) has a width (B2) of 3 mm to 20 mm.

8. An immersion bath roll in accordance with claim 1, wherein each groove (4) has a depth (T) of at least 50 micrometers.

9. An immersion bath roll in accordance with claim 1, wherein each groove (4) has a depth (T) of 100 to 200 micrometers.

10. An immersion bath roll in accordance with claim 1, wherein the protective layer (41) is additionally provided on the webs (5), wherein the protective layer (41) on the surface of the webs (5) has a thickness of at least twenty micrometers and preferentially of 50 to 100 micrometers.

11. A method for the manufacture an immersion bath roll for an immersion bath of liquid metal with a roll body (2), which extends along the longitudinal axis (A), as well as essentially cylindrical bearing journals (3) for cooperation with bearing sleeves, characterized in that at least one groove (4) is provided on every bearing journal (3), and extends in the circumferential direction over the total circumference of the bearing journal (3), wherein the groove (4) is filled with a protective layer (41) applied via by thermal spraying.

12. A method in accordance with claim 11, wherein the groove (4) is filled with a material containing molybdenum or a material containing molybdenum carbide.

13. A method in accordance with claim 11, wherein the groove (4), is filled either by plasma spraying, or flame spraying or arc spraying.
